(19) United States
(12) Patent Application Publication
(10) Pub. No.: US 2025/0249598 A1
(43) Pub. Date: Aug. 7, 2025

(54) ROBOT CONTROL DEVICE AND ROBOT SYSTEM

(71) Applicant: NIDEC INSTRUMENTS CORPORATION, Nagano (JP)

(72) Inventor: Hirokatsu OKUMURA, Nagano (JP)

(21) Appl. No.: 19/046,518

(22) Filed: Feb. 6, 2025

(30) Foreign Application Priority Data
Feb. 7, 2024 (JP) 2024-016814

(51) Int. Cl. B25J 13/06

(52) U.S. Cl. CPC B25J 13/06

(57) ABSTRACT

A group of programs and data necessary to control the robot is referred to as an essential data set, the essential data set already stored in a non-volatile memory provided in a robot and the essential data set stored in a non-volatile storage unit of a robot control device are compared at a start-up of the robot control device, and when a mismatch is detected, the essential data set stored in the robot control device is overwritten with the essential data set on the robot side.

### CROSS REFERENCE TO RELATED APPLICATION

The present invention claims priority under 35 U.S.C. § 119 to Japanese Application No. 2024-016814 filed Feb. 7, 2024, the entire content of which is incorporated herein by reference.

### BACKGROUND

### Field of the Invention

At least an embodiment of the present invention relates to an industrial robot (hereinafter, simply referred to as a “robot”) and particularly relates to a robot control device to control a robot and to a robot system composed of a combination of a robot and a robot control device.

### Description of the Related Documents

A robot generally includes: a manipulator including mutually coupled arms and a motor that drives a coupling unit of the arms; and a hand (also referred to as a tool, an end effector, or the like) attached to the manipulator. A robot control device is used to control such a robot. A robot system is composed of a robot and a robot control device to control the robot. In a robot in which a hand cannot be removed from a manipulator, the hand may be considered to be included in the manipulator, and in this case, the robot may be considered to be composed only of the manipulator. The robot control device controls a motor of each shaft of the robot in accordance with an externally input command. In order to control rotation of the motor, an encoder to detect the rotational position of the motor of each shaft is attached to the robot, and information on the rotational position acquired by the encoder is transmitted to the robot control device as needed basis.

In the manipulator and the hand constituting the robot, the numbers and dimensions of the arms and the hands, the connection relationship therebetween, the specifications of the mounted motor, and the like are different for each model of the robot. Configuration information on these robots is generally stored in the robot control device in advance. Therefore, the robot control device is prepared for each model of the robot. Accordingly, the robot control device cannot directly control a robot of a model other than the model that the robot control device is designed to control. When attempting to control a robot of another model using a robot control device of a certain model, it is necessary for an operator to confirm the model of the robot and replace the information inside the robot control device with robot configuration information conformable to the confirmed model. Therefore, the robot control device is prepared for each model of the robot. Further, even in the case of robots of the same model, there is inevitable individual variability among the robots, and when the robots are controlled by the robot control device, the robots are required to be controlled according to the individual variability. Examples of the individual variability include an offset value with respect to the original position. Although the original position, which is a posture serving as a reference for the operation of the manipulator or the hand, is defined, data on the rotational position indicated by the encoder for each motor when the manipulator or the hand is positioned at the original position vary for each individual manipulator or hand due to variations in installation of the motor or the encoder. Then, the individual variability is actually measured when assembly of the robot is completed, for example, and the data on the individual variability is subsequently stored in a storage unit of the robot control device. Therefore, even when the robot control device targets robots of the same model, when the robot is replaced with a robot of the same model, and the replacement robot is connected, it is not possible to control the robot with high accuracy, and it is necessary to adjust the robot control device again. Therefore, it is not easy to replace the robot with a robot of the same model and connect the replacement robot.

However, in a case of using a robot, in order to improve the efficiency of work using the robot and to flexibly cope with a change in a process or occurrence of a failure, there is a demand to replace and connect, with respect to robots with the same model, a robot control device for the model. Further, there is a case where although the models are different, the models may be considered to be the same model from in terms of the configuration and control as a robot main body. For example, when the exterior paint of robots varies depending on installation locations, the robots may be considered to be different models. In such a case, it is desirable that even robots of different models can be replaced and connected to the same robot control device.

As an attempt to enable replacement of a robot connected to a robot control device, JP2001-509441A discloses storing an operation and a setting parameter necessary to control the robot in a portable storage device and detachably attaching same to the robot control device. In the technique described in JP2001-509441A, when the robot connected to the robot control device is replaced or when a part such as an arm of the robot is replaced, the storage device attached to the robot control device is replaced with a storage device storing a parameter of a robot after replacement. JP2012-011494A discloses storing in advance geometric error data and an identification information (ID) of a robot in an auxiliary storage device provided in the robot, in which each time the robot connected is replaced, a robot control device reads out the geometric error data and the ID from the robot and verify same. When the robot control device determines that the robot has been replaced as a result of the verification, the robot control device corrects angle data in an operation program stored in the robot control device on the basis of the read geometric error data.

JP2020-179486A discloses assigning the same hardware identifier to robots with the same mechanism, storing a unique individual variability parameter and the hardware identifier in the robot, and storing common configuration information corresponding to the hardware identifier in the robot control device, in order to minimize the amount of data stored in the robot while facilitating replacement and connection of the robot control device with respect to the robot. The common configuration information is information that is common to robots with the same mechanism and can disregard individual variability. Meanwhile, the individual variability parameter is a parameter that cannot disregard individual variability even in robots with the same mechanism. The robot control device reads out the individual variability parameter and the hardware identifier from the connected robot, compares the read hardware identifier with the hardware identifier corresponding to the common configuration information, generates hardware definition information on the basis of the stored common configuration information and the read individual variability parameter when the hardware identifiers match, and controls the robot on the basis of the hardware definition information. In the technique described in JP2020-179486A, since the individual variability parameter and the hardware identifier are stored in a storage unit in an encoder attached to a motor of each shaft in the robot, when information to identify the individual robot is also stored in the storage unit, it is possible to detect replacement of the motor in the robot.

According to the techniques described in JP2001-509441A, JP2012-011494A, and JP2020-179486A, from the perspective of the robot, the robot control device connected to the robot can be easily replaced. However, the robot control device cannot always be replaced. In the case of the technique described in JP2020-179486A, for example, replacement with a robot control device that is not provided with the common configuration information corresponding to the model of the robot is impossible. In addition, application software executed in the robot control device is sometimes switched to control the robot depending on work to be executed by the robot. However, in such a case, it is not possible to switch to a robot control device in which desired application software is not installed. Even for robot control devices of the same model, firmware of the robot control devices may have different versions depending on the production periods or the like, and replacement with a robot control device with firmware of a different version may result in a difference in the function that can be executed by the robot.

The purpose of at least an embodiment of the present invention is to provide: a robot control device capable of easily replacing a robot control device connected to a robot, regardless of the version of firmware of the robot control device or application software and data stored in the robot control device; and a robot system including such a robot control device.

### SUMMARY

A robot control device according to one aspect of at least an embodiment of the present invention is a robot control device that is connected, in a replaceable manner, to a robot including a non-volatile first storage unit and that controls the robot, the robot control device including a processor, a RAM connected to the processor, and a second storage unit that holds an essential data set, which is a group of programs and data necessary to control the robot, and that includes a non-volatile memory, the robot control device executing, at a start-up, a verification process in which an essential data set already stored in the first storage unit and the essential data set stored in the second storage unit are compared, and an overwrite process in which when the verification process detects a mismatch, the essential data set stored in the second storage unit is overwritten with the essential data set stored in the first storage unit.

A robot system according to one aspect of at least an embodiment of the present invention is a robot system including a robot and a robot control device that is connected, in a replaceable manner, to the robot and controls the robot, in which the robot includes a non-volatile first storage unit accessible from the robot control device, the robot control device includes a processor, a RAM connected to the processor, and a second storage unit that holds an essential data set, which is a group of programs and data necessary to control the robot, and that includes a non-volatile memory, and a verification process in which an essential data set already stored in the first storage unit and the essential data set stored in the second storage unit are compared, and an overwrite process in which when the verification process detects a mismatch, the essential data set stored in the second storage unit is overwritten with the essential data set stored in the first storage unit are executed, in the robot control device at a start-up of the robot control device.

According to at least an embodiment of the present invention, a robot control device connected to a robot can be easily replaced regardless of the version of firmware of the robot control device or application software and data stored in the robot control device.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a block diagram showing a configuration of one mode of a robot system for carrying out at least an embodiment of the present invention; and

FIG. 2 is a flowchart illustrating an operation of a robot control device.

### DETAILED DESCRIPTION

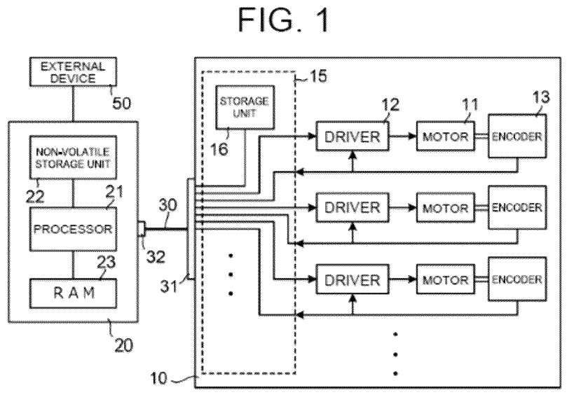

Next, a mode for carrying out at least an embodiment of the present invention will be described with reference to drawings. FIG. 1 is a block diagram showing a robot system according to one mode of at least an embodiment of the present invention. The illustrated robot system includes a robot 10 including a manipulator and a hand, and a robot control device 20 that controls the robot 10, and the robot 10 and the robot control device 20 are detachably connected to each other by a connection cable 30. A connector 31 for connection with the robot 10 is attached to one end of the connection cable 30, and a connector 32 for connection with the robot control device 20 is attached to the other end.

The robot 10 has a plurality of drive shafts, and includes, for each drive shaft, a motor 11 that is a servomotor and drives the drive shaft, a driver 12 that drives and controls the motor 11 on the basis of a command from the robot control device 20, and an encoder 13 that is attached to a rotation shaft of the motor 11 and detects a rotational position of the rotation shaft. Although not shown in the drawing, a speed reducer, a pulley, and the like are also attached to the motor 11. An output of the encoder 13 is fed back to the driver 12 for servocontrol, and is also sent to the robot control device 20. The encoder 13 may be provided with a small-capacity memory backed up by a battery so that the rotational position of the motor 11 and the like can be stored and held even when the power is turned off.

The driver 12 and the encoder 13 of each shaft both need to be connected to the robot control device 20 to transmit and receive a signal to and from the robot control device 20. At this time, when wiring connected to the driver 12 and wiring connected to the encoder 13 in the robot 10 are configured to be connected to the robot control device 20 separately for each shaft, erroneous connection is likely to occur between the robot 10 and the robot control device 20. Therefore, in this embodiment, a multi-conductor cable is used as the connection cable 30, the wiring connecting the drivers 12 and the encoders 13 of all shafts of the robot 10 is housed within this connection cable, and the robot 10 is provided with an interface board 15. The interface board 15 aggregates the wiring connected to the drivers 12 of the respective shafts and the wiring connected to the encoders 13 of the respective shafts for electrical connection to the connection cable 30. The interface board 15 is provided with a storage unit 16 including a large-capacity non-volatile memory such as a flash memory. The robot control device 20 can access the storage unit 16 via the connection cable 30 to read and write data. The storage unit 16 corresponds to a first storage unit.

The robot control device 20 executes software to determine a trajectory of the robot 10 according to a command input from an external device 50 and to control the robot 10 so that the robot 10 moves along the trajectory. The robot control device 20 includes: a processor 21 configured as a microprocessor or a microcomputer; a non-volatile storage unit 22 configured by a non-volatile memory such as a flash memory and functioning as an auxiliary storage device from the perspective of the processor 21; and a random access memory (RAM) 23 connected to the processor 21 and functioning as a main storage device directly accessible from the processor 21. The non-volatile storage unit 22 corresponds to a second storage unit. Although not shown in the drawing, an interface to the robot 10 and an interface to the external device 50 are also provided in the robot control device 20. The external device 50 may be, for example, a host device that is provided as a higher-level device and outputs a command to the robot control device 20, or may be a teaching pendant used for teaching the robot 10, and various devices are connected to the robot control device 20 as the external device 50 according to the purpose.

The robot control device 20 operates according to software and controls the robot 10. In the robot control device 20, the processor 21 executes firmware loaded into the RAM 23 and residing in the RAM 23 to generate a signal (specifically, a position command and/or a speed command) to be output to the driver 12 of each shaft on the basis of a command from the external device 50 and a signal from the encoder 13 of each shaft fed back from the robot 10. Depending on the situation, application software that can be executed under the control of firmware may also be loaded into the RAM 23, and the robot 10 may be controlled by the processor 21 executing the application software. Both the firmware and the application software are stored in the non-volatile storage unit 22, and when the robot control device 20 is started or restarted, the firmware and the application software are transferred from the non-volatile storage unit 22 to the RAM 23, and then executed by the processor 21.

In order to control the robot 10, a parameter indicating a hardware condition of the robot 10, that is, hardware definition information is also necessary. The hardware definition information is also stored in advance in the non-volatile storage unit 22, and is read out onto the RAM 23 by the firmware or the application software, and the processor 21 executes calculation necessary to control the robot 10 by using the hardware definition information read out onto the RAM 23. A group of parameters constituting the hardware definition information of the robot 10 is divided into common configuration information and an individual variability parameter. The common configuration information is information that is common to robots with the same mechanism and can disregard individual variability, and is, for example, one set of data describing the configuration of the robot, such as the number of shafts in the robot, the length of an arm or a hand constituting the robot, the connection relationship, and the specifications of the motor. On the other hand, the individual variability parameter is a parameter that cannot disregard individual variability even in robots with the same mechanism, and includes, for example, an offset value for each encoder with respect to the original position. Data obtained by teaching the robot 10, that is, teaching data are also stored in the non-volatile storage unit 22, and are read out from the non-volatile storage unit 22 onto the RAM 23 when controlling the movement of the robot 10 on the basis of the teaching data, and are used when performing calculation necessary to control the robot 10.

In the robot system of the present embodiment, when the robot control device 20 connected to the robot 10 is replaced to control the robot 10, the robot 10 can be normally controlled even using the robot control device 20 after replacement. To this end, a copy of a program and data necessary to control the robot 10 among the programs and data stored in the non-volatile storage unit 22 of the robot control device 20 is stored in the storage unit 16 including a non-volatile memory in the robot 10. Hereinafter, a group of programs and data necessary to control the robot 10 is referred to as an essential data set. The essential data set includes, for example, firmware of the robot control device 20 and the hardware definition information of the robot 10. When the robot 10 is controlled via the application software, the application software is also included in the essential data set. When teaching the robot 10 using the robot control device 20, teaching data obtained by teaching the robot may also be included in the essential data set. Then, a verification process of determining whether the robot control device 20 connected to the robot 10 has been replaced and an overwrite process of overwriting the essential data set stored in the non-volatile storage unit 22 of the robot control device 20 after replacement with the essential data set stored in the storage unit 16 of the robot 10 when it is determined in the verification process that the robot control device 20 has been replaced are executed, and the robot control device 20 is then restarted.

In the robot control device 20 after replacement, by restarting the robot control device 20, the essential data set in the robot control device 20 before replacement, which is loaded from the robot 10 by the overwrite process, is read into the RAM 23. Therefore, the robot control device 20 after replacement controls the robot 10 using the essential data set in the robot control device 20 before replacement loaded from the robot 10. That is, in the present embodiment, since the robot control device 20 after replacement controls the robot 10 using the same program and data as those of the robot control device 20 before replacement, the robot control device 20 connected to the robot 10 can be replaced without causing a difference in the function, performance, and the like that can be executed by the robot 10. When the robot control device 20 connected to the robot 10 is replaced, the robot control device 20 is in an inactive state.

The verification process is a process of determining whether the robot control device 20 connected to the robot 10 has been replaced, but is actually a process mainly executed by the robot control device 20 at a start-up of the robot control device 20. At a start-up, the robot control device 20 compares the essential data set stored in the non-volatile storage unit 22 of the own device with the essential data set stored in the storage unit 16 of the robot 10, and can determine that the robot control device 20 has not been replaced when the essential data sets match, and can determine that the robot control device 20 has been replaced and the own device is a robot control device after replacement when the essential data sets do not match. In the robot control device 20, the processor 21 executes the firmware loaded into the RAM 23 from the non-volatile storage unit 22 at the start-up, thereby performing the verification process and the overwrite process described above, and a restart process is further performed. Therefore, the firmware used in the robot control device 20 constituting the robot system of the present embodiment needs to be configured so that the processes from the verification process to a restart can be executed regardless of the version thereof.

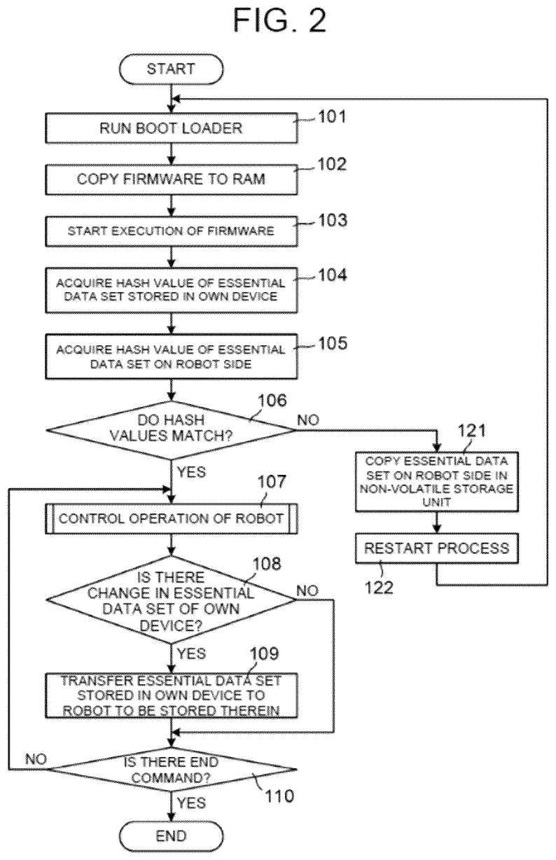

Hereinafter, an operation of the robot system of the present embodiment will be described in more detail with reference to the flowchart shown in FIG. 2. Here, it is assumed that the storage unit 16 of the robot 10 already stores a group of programs and data necessary to control the robot 10, that is, the essential data set. When a new robot control device 20 is connected to the robot 10 and the power of the robot control device 20 is turned on, the processor 21 of the robot control device 20 runs a boot loader according to a procedure determined in advance with respect to the processor in step 101. The boot loader is stored in a small-capacity non-volatile memory attached to the processor 21 or a predetermined address of the non-volatile storage unit 22. When the boot loader is run, the firmware stored in the non-volatile storage unit 22 is copied to the RAM 23 in step 102, and the execution of the boot loader ends. At this stage, the firmware resides in the RAM 23. Subsequently, in step 103, the processor 21 starts execution of the firmware loaded into and residing in the RAM 23. The boot loader may not be included in the essential data set because the boot loader may be stored in the processor 21 and cannot be rewritten, and the boot loader is not executed after the firmware starts to be executed and does not affect the control of the robot 10.

When the processor 21 executes the firmware, the verification process of verifying whether the essential data set stored in the non-volatile storage unit 22 matches the essential data set stored in the storage unit 16 of the robot 10 is performed. Here, in order to execute the verification process in a short time, the verification process is executed depending on whether hash values calculated for the essential data sets match. The firmware acquires the hash value of the essential data set stored in the non-volatile storage unit 22 of the own device in step 104, acquires the hash value of the essential data set stored in the storage unit 16 of the robot 10 in step 105, and determines whether both hash values match in step 106. If the hash values match, it can be determined that the essential data set stored in the non-volatile storage unit 22 matches the essential data set stored in the storage unit 16 of the robot 10, and the verification process ends. Naturally, the hash function used to calculate the hash value of the essential data set stored in the non-volatile storage unit 22 needs to be the same as the hash function used to calculate the hash value of the essential data set stored in the storage unit 16. As one example, it is possible to bundle the essential data set into one compressed file (for example, a zip-format file) and calculate the hash value of the compressed file. When the hash values are acquired in steps 104 and 105, the hash function may be applied to the stored essential data set to obtain the hash value in each time. Alternatively, the hash value may also be calculated when the essential data set is stored in the non-volatile storage unit 22 or the storage unit 16, the hash value may be stored together with the essential data set, and the hash values stored in advance may be read out when the hash values are acquired in steps 104 and 105.

If the hash values match in step 106, the processor 21 executes control of the robot 10 using the essential data set already loaded into the RAM 23 in step 107. The essential data set, that is, any of the programs and data necessary to control the robot 10, may be changed while controlling the robot 10. For example, the teaching data are changed when teaching the robot 10, and the individual variability data are changed when calibrating the robot 10. Firmware update, application data update, or replacement may be performed. When the essential data set is changed while the robot 10 is controlled, the changed essential data set is written into the non-volatile storage unit 22. In addition, this change needs to be reflected in the essential data set stored in the storage unit 16 of the robot 10. The firmware monitors such a change in the essential data set, determines whether there is a change in the essential data set stored in the robot control device 20 in step 108. When there is a change, the firmware transfers the changed essential data set stored in the non-volatile storage unit 22 to the robot 10 in step 109, stores same in the storage unit 16, and then advances the process to step 110. On the other hand, when it is determined in step 108 that the essential data set has not been changed, the firmware directly advances the process to step 110. In the stage in which the process proceeds to step 110, the control of the robot 10 by the robot control device 20 continues. In step 110, it is determined whether a command to end the control of the robot 10 is given to the robot control device 20. When it is determined in step 110 that the end command has not been input, the process from step 107 is repeated to continue the control of the robot 10. When it is determined in step 110 that the end command has been input, the robot control device 20 is stopped as it is.

The case in which it is determined in step 106 that the hash values do not match means that the robot control device 20 has been replaced, and the overwrite process is subsequently executed. In the overwrite process, the essential data set stored in the storage unit 16 of the robot 10 is transferred to the robot control device 20 by the firmware in step 121, and the essential data set already stored in the non-volatile storage unit 22 is replaced by the essential data set transferred from the robot 10. Thereafter, in step 122, the robot control device 20 is restarted by the firmware. When the robot control device 20 is restarted, the processor 21 first executes the boot loader, and thus the processes from step 101 is repeated.

In the robot system described above, the essential data set, which is programs and data necessary to control the robot 10, is stored in the non-volatile storage unit 22 of the robot control device 20 and is allowed to be loaded into the RAM 23, and a backup of the essential data set is held in the storage unit 16 in the robot 10. Then, when the robot control device 20 connected to the robot 10 is replaced, the essential data set stored in the robot 10 as the backup is written back to the non-volatile storage unit 22 of the robot control device 20 after the replacement, so that the robot control device 20 after the replacement performs the same operation as that of the robot control device 20 before the replacement. As a result, according to the present embodiment, the robot control device 20 connected to the robot 10 can be easily replaced regardless of the version of the firmware of the robot control device 20 after the replacement or the application software and data stored in the robot control device 20 after the replacement.

In the example described above, the hash value of the essential data set is acquired in order to perform the verification process. Although one hash value may be calculated from the entire essential data set, an essential data set may be divided into a plurality of blocks, the hash value may be calculated for each block, and the comparison of the hash values in the verification process may also be performed for each block. For example, when one essential data set is composed of a plurality of types of programs and data such as firmware, application software, hardware definition information, and teaching data, these programs and data can each be taken as a block. In a case where the essential data set is composed of a plurality of blocks, since it is sufficient to perform the overwrite process only for a block in which the hash value in the robot control device 20 differs from the hash value in the robot 10, it is possible to reduce the time for transferring the programs or the data for the overwrite process. When the hash value is calculated in advance and stored in the non-volatile storage unit 22 or the storage unit 16, the hash value may be calculated again only for a changed block, and thus the load in calculating the hash value can be reduced. In general, since the frequency of change of firmware or hardware definition information is low while the teaching data are frequently changed, when the teaching data are taken as one block and the other programs and data are taken as another one or more blocks, the load in calculating the hash value is reduced, and the data transferred from the robot 10 to the robot control device 20 at the start-up of the robot control device 20 is only the teaching data in many cases, and the transfer time can be shortened accordingly.

The configuration for carrying out at least an embodiment of the present invention has been described above. However, the above-described techniques can adopt the following configurations.
(1) A robot control device that is connected, in a replaceable manner, to a robot including a non-volatile first storage unit and controls the robot, the robot control device including a processor, a RAM connected to the processor, and a second storage unit that holds an essential data set, which is a group of programs and data necessary to control the robot, and that includes a non-volatile memory, the robot control device executing a verification process in which an essential data set already stored in the first storage unit and the essential data set stored in the second storage unit are compared at a start-up, and an overwrite process in which when the verification process detects a mismatch, the essential data set stored in the second storage unit is overwritten with the essential data set stored in the first storage unit.
(2) The robot control device according to (1), in which when the essential data set is changed while the robot is controlled by the robot control device, the changed essential data set is stored in the second storage unit, transferred to the robot, and stored in the first storage unit.
(3) The robot control device according to (1) or (2), in which the essential data set includes firmware loaded into the RAM from the second storage unit at a start-up of the robot control device and residing in the RAM, and the firmware executes the verification process, and when the verification process detects a mismatch, the firmware executes the overwrite process, and the robot control device is restarted.
(4) The robot control device according to any of (1) to (3), in which the verification process is a process in which a hash value calculated for the essential data set stored in the first storage unit is compared with a hash value calculated for the essential data set stored in the second storage unit.
(5) The robot control device according to (4), in which the essential data set is composed of a plurality of blocks, and the hash value is calculated for each of the blocks and used in the verification process.
(6) The robot control device according to (5), in which in the overwrite process, the essential data set stored in the second storage unit is overwritten with the essential data set stored in the first storage unit only for the block which is determined to include a mismatch as a result of the verification process.
(7) A robot system including a robot and a robot control device that is connected, in a replaceable manner, to the robot and controls the robot, in which the robot includes a non-volatile first storage unit accessible from the robot control device, the robot control device includes a processor, a RAM connected to the processor, and a second storage unit that holds an essential data set, which is a group of programs and data necessary to control the robot and that includes a non-volatile memory, and a verification process in which an essential data set already stored in the first storage unit and the essential data set stored in the second storage unit are compared, and an overwrite process in which when the verification process detects a mismatch, the essential data set stored in the second storage unit is overwritten with the essential data set stored in the first storage unit are executed, in the robot control device at a start-up of the robot control device.
(8) The robot system according to (7), in which when the essential data set is changed while the robot is controlled by the robot control device, the changed essential data set is stored in the second storage unit, transferred to the robot, and stored in the first storage unit.
(9) The robot system according to (7) or (8), in which the essential data set includes firmware loaded into the RAM from the second storage unit at a start-up of the robot control device and residing in the RAM, and in the robot control device, the firmware executes the verification process, and when the verification process detects a mismatch, the firmware executes the overwrite process, and the robot control device is restarted.
(10) The robot system according to any of (7) to (9), in which the essential data set includes: common configuration information that is common to robots with the same mechanism and can disregard individual variability; and an individual variability parameter that cannot disregard individual variability even in robots with the same mechanism.
(11) The robot system according to any of (7) to (10), in which the verification process is a process in which a hash value calculated for the essential data set stored in the first storage unit is compared with a hash value calculated for the essential data set stored in the second storage unit.
(12) The robot system according to (10), in which the essential data set is composed of a plurality of blocks, and the hash value is calculated for each of the blocks and used in the verification process.
(13) The robot system according to (12), in which in the overwrite process, the essential data set stored in the second storage unit is overwritten with the essential data set stored in the first storage unit only for the block which is determined to include a mismatch as a result of the verification process.
(14) The robot system according to (13), in which one of the plurality of blocks constituting the essential data set is teaching data of the robot.

According to the configurations described in (1) and (7), since when replacement of the robot control device connected to the robot has been detected, the essential data set of the robot control device after replacement is overwritten with the essential data set stored in the robot as a backup, it can be ensured that the operation of the robot control device is the same before and after the replacement, and the robot control device connected to the robot is easily replaced.

According to the configurations described in (2) and (8), since when the essential data set is changed due to teaching or the like while the robot is controlled by the robot control device, the change can be reflected also in the essential data set stored in the robot as a backup, the robot control device connected to the robot is easily replaced even when a change intended by a user is included in the essential data set.

According to the configurations described in (3) and (9), when firmware of the robot control device is included in the essential data set, the robot control device connected to the robot can be replaced without taking differences in firmware versions and the like into account.

According to the configurations described in (4) and (11), the verification process for the essential data sets can be executed in a short time by utilizing the hash values calculated for the essential data sets.

According to the configurations described in (5) and (12), since when the update frequency varies by block in the essential data set, the hash value for a block that has not been updated does not need to be calculated again, the load in calculating the hash value is reduced.

According to the configurations described in (6) and (13), since the essential data set is not overwritten in the robot control device for the matched blocks as a result of verification of the hash values, the data transfer amount during the overwrite process is reduced.

According to the configuration described in (10), since the common configuration information and the individual variability parameter can be separately managed, data necessary to control the robot are easily managed, and replacement with a robot control device prepared for a robot with a different configuration is also possible.

According to the configuration described in (14), since when teaching data expected to have a high update frequency is handled as a single block, it is sufficient to only calculate the hash value for the teaching data and transfer the teaching data in many cases, processing load is reduced.

What is claimed is:

1. A robot control device connected, in a replaceable manner, to a robot including a non-volatile first storage unit and controlling the robot, the robot control device comprising
a processor;
a RAM connected to the processor; and
a second storage unit that holds an essential data set, which is a group of programs and data necessary to control the robot and that comprises a non-volatile memory, the robot control device executing
a verification process in which an essential data set already stored in the first storage unit and the essential data set stored in the second storage unit are compared at a start-up, and
an overwrite process in which when the verification process detects a mismatch, the essential data set stored in the second storage unit is overwritten with the essential data set stored in the first storage unit.

2. The robot control device according to claim 1, wherein
when the essential data set is changed while the robot is controlled by the robot control device, the changed essential data set is stored in the second storage unit, transferred to the robot, and stored in the first storage unit.

3. The robot control device according to claim 1, wherein
the essential data set comprises firmware loaded into the RAM from the second storage unit at a start-up of the robot control device and residing in the RAM, and
the firmware executes the verification process, and when the verification process detects a mismatch, the firmware executes the overwrite process, and the robot control device is restarted.

4. The robot control device according to claim 1, wherein
the verification process is a process in which a hash value calculated for the essential data set stored in the first storage unit is compared with a hash value calculated for the essential data set stored in the second storage unit.

5. The robot control device according to claim 4, wherein
the essential data set is composed of a plurality of blocks, and the hash value is calculated for each of the blocks and used in the verification process.

6. The robot control device according to claim 5, wherein
in the overwrite process, the essential data set stored in the second storage unit is overwritten with the essential data set stored in the first storage unit only for the block which is determined to include a mismatch as a result of the verification process.

7. A robot system comprising:
a robot; and
a robot control device that is connected, in a replaceable manner, to the robot and controls the robot, wherein
the robot comprises a non-volatile first storage unit accessible from the robot control device,
the robot control device comprises a processor, a RAM connected to the processor, and a second storage unit that holds an essential data set, which is a group of programs and data necessary to control the robot, and that comprises a non-volatile memory, and
a verification process in which an essential data set already stored in the first storage unit and the essential data set stored in the second storage unit are compared, and an overwrite process in which when the verification process detects a mismatch, the essential data set stored in the second storage unit is overwritten with the essential data set stored in the first storage unit are executed, in the robot control device at a start-up of the robot control device.

8. The robot system according to claim 7, wherein
when the essential data set is changed while the robot is controlled by the robot control device, the changed essential data set is stored in the second storage unit, transferred to the robot, and stored in the first storage unit.

9. The robot system according to claim 7, wherein
the essential data set comprises firmware loaded into the RAM from the second storage unit at a start-up of the robot control device and residing in the RAM, and
in the robot control device, the firmware executes the verification process, and when the verification process detects a mismatch, the firmware executes the overwrite process, and the robot control device is restarted.

10. The robot system according to claim 9, wherein
the essential data set comprises: common configuration information that is common to robots with the same mechanism and can disregard individual variability; and an individual variability parameter that cannot disregard individual variability even in robots with the same mechanism.

11. The robot system according to claim 7, wherein
the verification process is a process in which a hash value calculated for the essential data set stored in the first storage unit is compared with a hash value calculated for the essential data set stored in the second storage unit.

12. The robot system according to claim 11, wherein
the essential data set is composed of a plurality of blocks, and the hash value is calculated for each of the blocks and used in the verification process.

13. The robot system according to claim 12, wherein
in the overwrite process, the essential data set stored in the second storage unit is overwritten with the essential data set stored in the first storage unit only for the block which is determined to include a mismatch as a result of the verification process.

14. The robot system according to claim 13, wherein
one of the plurality of blocks constituting the essential data set is teaching data of the robot.
